(19) United States
(12) Patent Application Publication
(10) Pub. No.: US 2026/0105525 A1
(43) Pub. Date: Apr. 16, 2026

(54) DATA QUANTIZATION METHOD BASED ON DEFINITE VALUES, ESTIMATED VALUES, AND WEIGHT VALUES

(71) Applicant: TITECHNOLOGY CO., LTD., Busan (KR)

(72) Inventor: Dong Hoon KIM, Tongyeong-si (KR)

(21) Appl. No.: 19/332,623

(22) Filed: Sep. 18, 2025

Related U.S. Application Data
(63) Continuation-in-part of application No. 18/635,981, filed on Apr. 15, 2024, now abandoned.
Application No. 18/635,981 is a continuation of application No. 17/779,524, now abandoned.

(30) Foreign Application Priority Data
Nov. 25, 2019 (KR) 10-2019-0151843

(51) Int. Cl. G06Q 40/06

(52) U.S. Cl. CPC G06Q 40/06

(57) ABSTRACT

A data quantization apparatus collecting data corresponding to a pre-set definite value for each period of a previous section pre-set on the basis of a current date, an estimated value and definite value for a current year on the basis of the current date, and an estimated value for each period of a subsequent section pre-set based on the current date; calculating at least one comparison reference value on the basis of a provision value after collecting the provision value that can be compared with the estimated value and the definite value; and quantizing the data for each period and for each section via a method for assigning a weight to the current year for each period, and each period of the previous section and subsequent section, by comparing the definite value for each period of the previous section, the definite value for each section of the current year, and the estimated value for each period of the subsequent section with the comparison reference value.

### CROSS-REFERENCE TO RELATED APPLICATIONS

This application is a Continuation-In-Part (CIP) of Application No. U.S. patent application Ser. No. 18/635,981, filed on Apr. 15, 2024, which is a Continuation of Application No. U.S. patent application Ser. No. 17/779,524, filed on May 24, 2022, which in turn claims the benefit of International Application No. PCT/KR2020/013647, filed on Oct. 7, 2020, and Korean Application No. 10-2019-0151843 filed on Nov. 25, 2019, the disclosures of which are incorporated by reference into the present application.

### TECHNICAL FIELD

The present invention relates to a data quantization method based on definite values, estimated values, and weight values.

### BACKGROUND ART

Financial technology (FinTech) has emerged as a transformative force in the financial and banking industry, driven by advances in computing and communication technologies. FinTech encompasses digital platforms and services that process transactions, manage assets, forecast important values such as stock price and company financial data, and enable new modes of interaction, such as crowdfunding. Unlike traditional systems, FinTech solutions integrate financial operations with intelligent information technologies to provide services that are more automated, data-driven, and adaptive.

As digital transactions increase, vast amounts of financial data are generated. To utilize this data effectively, financial systems are increasingly employing automated analysis to identify customer behavior patterns and investment preferences. Digital advisory systems, including robo-advisors, represent one such application. These systems automate tasks such as value prediction, customer profiling, and product recommendation, reducing reliance on conventional manual and resource-intensive processes. However, existing methods often lack the technical sophistication to efficiently process heterogeneous data and provide reliable predictions of important values in real time.

To achieve reliable predictions, for instance, it is essential to convert diverse raw data into quantifiable forms suitable for computational processing and perform rigorous quantitative analysis. Conventional approaches remain inadequate, as they fail to provide consistent methods for handling large-scale, heterogeneous data while maintaining prediction accuracy.

As an example, traditional computer programs for financial forecasting, such as company financial and stock price prediction, typically rely on static statistical models or fixed algorithms. These methods treat all input variables equally, overlooking the dynamic and nonlinear influence of different market factors. This technical limitation leads to inaccurate or delayed outputs. Moreover, the inability of such systems to assign differentiated weight values to relevant historical and real-time inputs constrains the overall performance and usefulness of predictive computing systems. Addressing these limitations requires improved data processing techniques that enhance the accuracy and efficiency of computer-implemented prediction models.

[Prior Art Document] (Patent Document 1) Korean Patent Registration No. 10-1913591 (Registered on Oct. 25, 2018).

### DISCLOSURE OF INVENTION

### Technical Problem

Therefore, the present invention has been made in view of the above problems, and it is an object of the present invention to provide a data quantization method based on definite values, estimated values, and weight values, which can facilitate data management and analysis by quantizing data in a method of collecting a definite value of each period of a previous section based on the current date, an estimated value and a definite value of each period of a section including the current date, and an estimated value of each period of a subsequent section, and assigning a weight using the collected estimated and definite values and a comparison reference value.

In addition, the present invention provides a data quantization method based on definite values and estimated values, which allows a user to easily recognize complex data by providing quantized data in the form of a graph.

In addition, the present invention provides a data quantization method based on definite values and estimated values, which can increase user's accessibility to data analysis by providing a graph for comparison in which a graph corresponding to association data associated with data is included in a graph of quantized data.

The problem to be solved by the present invention is not limited to those mentioned above, and unmentioned other problems to be solved can be clearly understood by those skilled in the art from the following description.

### Technical Solution

To accomplish the above objects, according to one aspect of the present invention, there is provided a data quantization method based on definite values and estimated values, the method comprising the steps of: collecting, by a data quantization apparatus from at least two information manager-side apparatuses, data corresponding to a definite value of each preset period of a preset previous section based on a current date, an estimated value and a definite value of a current year based on the current date, and an estimated value of each period of a preset subsequent section based on the current date; collecting a provision value that can be compared with the estimated values and the definite values, and calculating at least one comparison reference value on the basis of the provision value; and quantizing the data of each period and section in a method of assigning a weight to the current year of each period and to each period of the previous section and subsequent section, by comparing the definite value of each period of the previous section, the definite value of each period of the current year, and the estimated value of each period of the subsequent section with the comparison reference value.

According to the present invention, the quantizing step may include the steps of: calculating an average value for each period or each section using the definite value of each period of the previous section, the definite value of each period of the current year, and the estimated value of each period of the subsequent section; and calculating a score for each period of the previous section, the current year, and the subsequent section, by assigning a negative weight when the calculated average value is greater than the comparison reference value, and assigning a positive otherwise.

According to the present invention, the data quantization method may further include the steps of: calculating a total score of the previous section, the current year, and the subsequent section based on the score of each period of the previous section, the current year, and the subsequent section; and generating a quantized graph using the total score and the score of each period of the previous section, the current year, and the subsequent section.

According to the present invention, the data quantization method may further include the steps of: receiving association data related to the data from the outside; and generating a comparative graph including a graph corresponding to the association data in a quantized graph.

According to the present invention, the collected data may be estimated and definite values of performance, and the provision value for comparison may be net income and operating income, and an association data is an index-related graph.

According to the present invention, the step of generating the comparison reference value may include the step of collecting the provision value through analysis of the data provided by a medium that posts data related to the provision value on the Internet, and then generating the comparison reference value on the basis of the collected provision value.

### Advantageous Effects

According to the technical solution of the present invention described above, it is possible to facilitate data management and analysis by quantizing data in a method of collecting a definite value of each period of a previous section based on the current date, an estimated value and a definite value of each period of a section including the current date, and an estimated value of each period of a subsequent section, and assigning a weight using the collected estimated and definite values and a comparison reference value.

In addition, according to the technical solution of the present invention described above, as quantized data is provided in the form of a graph, it is possible to improve accessibility that allows a user to easily recognize complex data.

In addition, according to the technical solution of the present invention described above, user's accessibility to data analysis may be increased by providing a graph for comparison in which a graph corresponding to association data associated with data is included in a graph of quantized data.

### BRIEF DESCRIPTION OF THE DRAWINGS

FIG. 1 is a view showing the overall configuration of a data quantization system based on definite values and estimated values according to an embodiment of the present invention.

FIG. 2 is a block diagram showing a detailed configuration of a data quantization apparatus according to an embodiment of the present invention.

FIG. 3 is a flowchart illustrating the steps of processing data by a data quantization apparatus according to an embodiment of the present invention.

FIG. 4 is an exemplary view showing a graph for comparison provided by a data quantization apparatus according to an embodiment of the present invention.

### BEST MODE FOR CARRYING OUT THE INVENTION

Hereinafter, specific embodiments of the present invention will be described with reference to the drawings. The following detailed description is provided for comprehensive understanding of the methods, apparatuses, and/or systems described in this specification. However, this is merely an example, and the present invention is not limited thereto.

In describing the embodiments of the present invention, when it is determined that detailed description of a known technique related to the present invention may unnecessarily obscure the gist of the present invention, the detailed description will be omitted. In addition, the terms described below are terms defined in consideration of functions of the present invention, and may vary according to the intention of a user or an operator, custom, or the like. Therefore, the definitions should be made based on the content throughout this specification. The terms used in the detailed description are only to describe the embodiments of the present invention, and should not be restrictive. Unless explicitly used otherwise, expressions of singular forms include a meaning of plural forms. In this description, expressions such as “comprise” or “provide” are intended to indicate certain features, numbers, steps, operations, elements, or some or a combination of these, and should not be construed to exclude the presence or possibility of one or more other features, numbers, steps, operations, elements, or some or a combination of these, other than those described.

Hereinafter, an apparatus and method for quantizing data based on definite values and estimated values will be described with reference to the accompanying drawings.

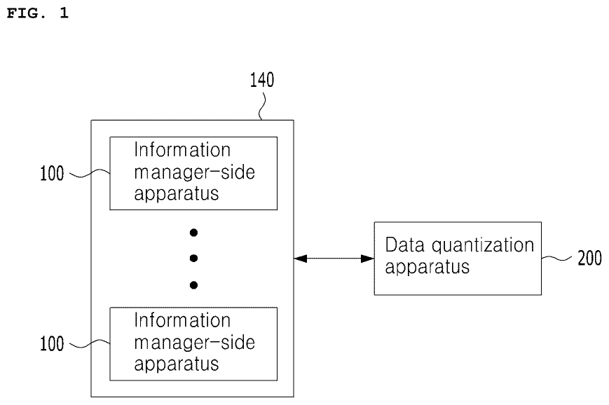

FIG. 1 is a view showing the overall configuration of a data quantization system based on definite values and estimated values according to an embodiment of the present invention.

As shown in FIG. 1, the data quantization system may include a plurality of information manager-side apparatuses 100 and a data quantization apparatus 200 connected to each other through a network. An apparatus and method for granting recommendation reward points will be described.

The information manager-side apparatus 100 is a means for managing data corresponding to estimated values and definite values for the data quantization apparatus 200, and for example, it may be a computing device managed by a securities company, a school, a company managed by financial statements, or the like, but it is not limited thereto.

That is, the information manager-side apparatus 100 may manage an estimated value and a definite value of each period during the periods before and after the period, which are set in advance based on the current year, and may provide the estimated value and the definite value to the data quantization apparatus 200. Specifically, the information manager-side apparatus 100 may manage definite values of each preset period, for example, quarterly definite values, of previous years on the basis of the current year, quarterly estimated values of the current year and quarterly estimated values of subsequent years on the basis of the definite values, and the like, and may also change the estimated values to definite values as quarters are settled in the current year.

For example, when the current reference date of Dec. 31, 2019 is set as a reference, the information manager-side apparatus 100 may set and manage the quarterly estimated values of the next year on the basis of the quarterly definite values of the current year based on the current date (hereinafter, referred to as the ‘current reference date’), and manage the definite values of the last year based on the current reference date.

In addition, the information manager-side apparatus 100 may change the quarterly estimated values of the next year to definite values as the quarters of the next year reach.

In an embodiment of the present invention, the information manager-side apparatus 100 may transmit the data described above, i.e., the estimated values and the definite values, to the data quantization apparatus 200 in rea-time.

Meanwhile, according to an embodiment of the present invention, although a preset period has been described as a quarter, it may be daily, weekly, monthly, yearly, or the like, and is not limited thereto. That is, the preset period may be determined by the data quantization apparatus 200.

In addition, in an embodiment of the present invention, the information manager-side apparatus 100 may provide at least one or more provision values for comparison. For example, the information manager-side apparatus 100 may provide operating income and net income as provision values when data corresponding to estimated values and definite values related to performance are provided, and provide a provision value such as an achievement rate of research and development or the like when data corresponding to estimated values and definite values related to research and development is provided.

Although an example of receiving a provision value from the information manager-side apparatus 100 has been described in the embodiment of the present invention, the data quantization apparatus 200 may collect the provision value through big data analysis. Specifically, the data quantization apparatus 200 may collect provision values on the basis of data opened through a website (a website operated by an analyst or the like), which is related to data corresponding to estimated values and definite values related to performance, and the Internet.

The data quantization apparatus 200 may calculate an average value on the basis of the provision values provided by a plurality of information manager-side apparatuses 100 and the number of information managers who have provided the provision values, and calculate a score of each period in a manner of setting the average value as a comparison reference value and then assigning a weight through comparison of the set comparison reference value with the definite and estimated values of a preset period. Specifically, the data quantization apparatus 200 may calculate a score of each period by assigning a preset negative weight (−a) when the comparison reference value is greater than the definite value (estimated value) of each period, and calculate a score of each period by assigning a preset positive weight (a) when the comparison reference value is smaller than or equal to the definite value (estimated value) of each period.

In addition, the data quantization apparatus 200 may calculate a total score of each year in a manner of calculating a total score of a corresponding year using the score of each period. Specifically, the data quantization apparatus 200 may calculate a total score of the current year using quarterly scores of the current year, calculate a total score of the last year using quarterly scores of the last year, and calculate a total score of the next year using quarterly scores of the next year.

On the other hand, the data quantization apparatus 200 may generate and provide a quantized graph on the basis of the score of each period and the total score of each year, and provide data that can compare the tendency of change in the association data through comparison of data associated with data (hereinafter, referred to as ‘association data’) with the quantized graph.

The data quantization apparatus 200 may provide a graph using the score of each period within a section and a cumulative score obtained by summing the scores of each period within a section based on the section set by the user, and provide a graph that can be compared by reflecting the association data within the section set by the user on the graph.

Although an example of receiving a provision value from the information manager-side apparatus 100 has been described in the embodiment of the present invention, the data quantization apparatus 200 may collect the provision value through big data analysis. Specifically, the data quantization apparatus 200 may collect provision values on the basis of data opened through a website (a website operated by an analyst or the like), which is related to data corresponding to estimated values and definite values related to performance, and the Internet.

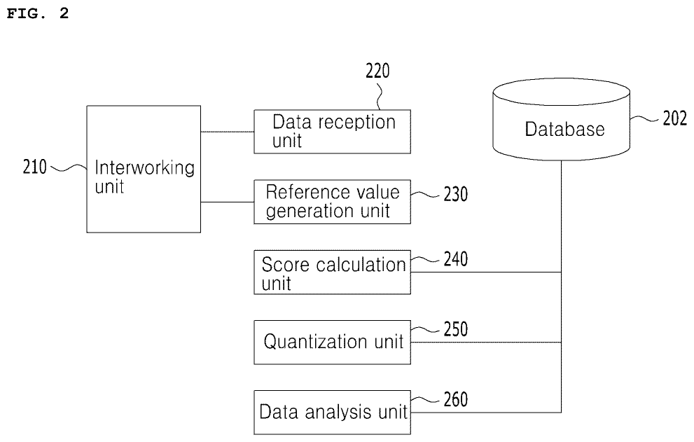

To this end, as shown in FIG. 2, the data quantization apparatus 200 according to an embodiment of the present invention may include an interworking unit 210 for interworking with the information manager-side apparatus 100; a data reception unit 220 for receiving data from the information manager-side apparatus 100 connected through the interworking unit 210 and storing the data in a database 202; a reference value generation unit 230 for generating a comparison reference value based on the provision value provided by the information manager-side apparatus 100; a score calculation unit 240 for calculating a score of each period based on a preset weight using the data stored in the database 202 and the comparison reference value; a quantization unit 250 for generating a quantized graph using the score of each period; and a data analysis unit 260 for providing a comparative graph that reflects association data in the quantized graph, and providing a comparison result data.

In an embodiment of the present invention, the interworking unit 210 may interwork with various media on the Internet, for example, a research and development management medium, an information medium managed by an analyst, a medium operated by an organization, and the like, and may collect data managed in each of the media through the interworking, and acquire a provision value by analyzing the collected data. In this case, the reference value generation unit 230 may calculate a comparison reference value on the basis of a result of adding the number of media providing the provision value and the provision value.

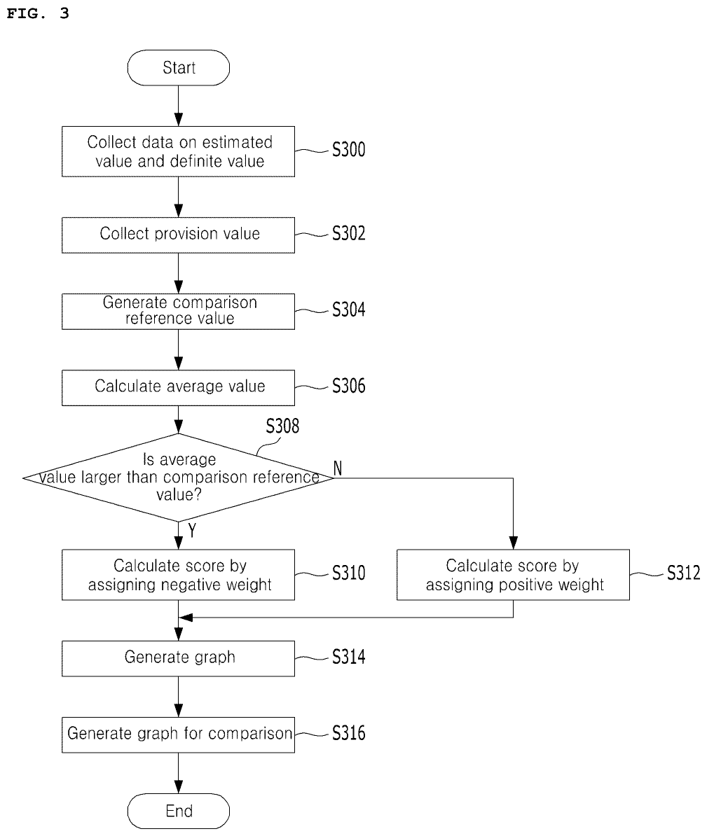

A process of quantizing data including estimated values and definite values by the data quantization apparatus 200 having the configuration as described above will be described with reference to FIG. 3.

FIG. 3 is a flowchart illustrating a process of quantizing data of estimated values and definite values by the data quantization apparatus 200 according to an embodiment of the present invention.

For convenience of explanation, it will be described assuming that the period is a quarter, and the current reference date is Dec. 31, 2019.

As shown in FIG. 3, the data quantization apparatus 200 is provided with quarterly definite values of the previous year 2018, quarterly definite values of the current year, and quarterly estimated values of the next year 2020 from a plurality of information manager-side apparatuses 100 through the interworking unit 210, and stores the values in the database 202 (S300).

In addition, the data quantization apparatus 200 collects data on the provision values, i.e., data on net income and operating income, that can be used as a reference value in relation to performance through interworking with the information manager-side apparatus 100 or various media (S302).

Then, the data quantization apparatus 200 calculates an average value of the collected provision values, and sets the average value as a comparison reference value (S304).

In addition, the data quantization apparatus 200 calculates quarterly average values of the current year with respect to the definite values of the current year, quarterly average values of the previous year with respect to the definite values of the previous year, quarterly average values of the next year with respect to the estimated values of the next year, and the like (S306).

Then, the data quantization apparatus 200 determines whether the first quarter average value of the current year is greater than the comparison reference value (S308).

The data quantization apparatus 200 calculates a score by assigning a negative weight (−a, a is a real number, a symbol, a character, or the like) when the first quarter average value of the current year is larger than the reference value as a result of the determination at S308, and a positive weight (a) when the first quarter average value of the current year is smaller than or equal to the reference value (S310, S312).

Quarterly scores of the current year, the previous year, and the next year may be calculated by repeatedly performing S308, S310, and S312 described above.

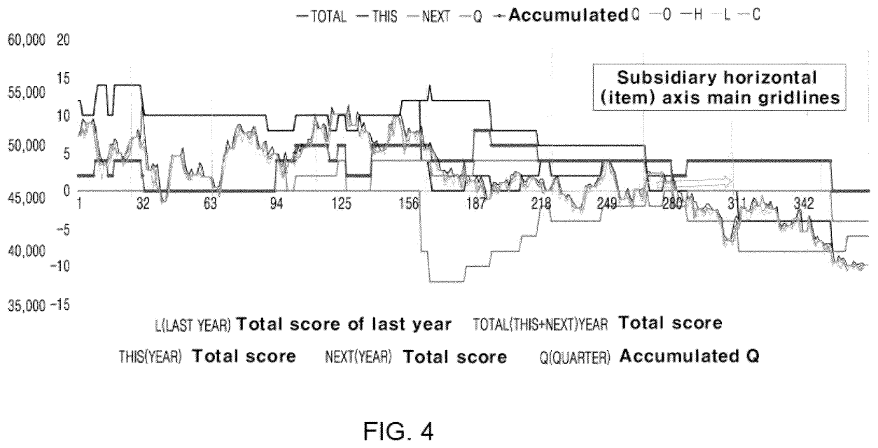

The data quantization apparatus 200 generates a graph (chart) based on the scores calculated through the steps as described above (S314). Specifically, the data quantization apparatus 200 generates a graph expressing the total score of the current year, the total score of the previous year, the total score of the next year, and a score obtained by adding the total score of the next year and the total score of the current year as shown in FIG. 4.

In addition, the data quantization apparatus 200 generates a graph for comparison that merges a chart corresponding to association data, for example, index-related data, with the graph (S316).

The operation process of the information manager-side apparatus 100 and the data quantization apparatus 200, in the case where the data is related to performance, the period is a quarter, and the current reference date is Dec. 31, 2019, will be described as an example.

First, the plurality of information manager-side apparatuses 100 may provide quarterly performance definite values of the current year, quarterly performance estimated values of the next year, and quarterly performance definite values of the last year on the basis of the current reference date.

Accordingly, the data quantization apparatus 200 may calculate reference values, such as reference operating income, reference net income, and the like, based on the provision values provided by the plurality of information manager-side apparatuses 100.

Then, the data quantization apparatus 200 may calculate a score by assigning a weight through comparison of the quarterly operating income of the last year (operating income calculated based on the performance definite values) with the reference operating income on the basis of the current reference date. Specifically, the data quantization apparatus 200 may calculate a score by assigning a negative weight (−a) when the quarterly operating income is greater than the reference operating income, calculate a score by assigning a positive weight (a) when the quarterly operating income is smaller than or equal to the reference operating income, calculate a score by assigning a negative weight (−a) when the net income of the last year (net income calculated based on the performance definite value) is greater than the reference net income, and calculate a score by assigning a positive weight (a) when the quarterly net income is smaller than or equal to the reference net income.

In addition, the data quantization apparatus 200 may calculate a score by assigning a negative weight (−a) when the quarterly operating income of the next year (calculated based on the performance estimated value of the next year) is greater than the reference operating income, calculate a score by assigning a positive weight (a) when the quarterly operating income of the next year is smaller than or equal to the reference operating income, calculate a score by assigning a negative weight (−a) when the net income of the next year (net income calculated based on the performance estimated value) is greater than the reference net income, and calculate a score by assigning a positive weight (a) when the quarterly net income of the next year is smaller than or equal to the reference net income.

As described above, the data quantization apparatus 200 according to an embodiment of the present invention may calculate a score of each period preset based on the current reference date, e.g., 1 year, 2 years, . . . , n years before and after the preset period, and a score of each year by adding the scores of the periods, and generate a quantized graph based on the calculated scores.

In addition, the data quantization apparatus 200 may generate a graph that compares the performance and the index. Specifically, the data quantization apparatus 200 may provide comparison data according to the tendency of change in the index with respect to the performance through comparison of the performance-related index change graph (provided from the outside) with the quantized graph.

Meanwhile, combinations of the blocks in the accompanying block diagram and the steps in the flowchart may be performed by computer program instructions. Since these computer program instructions may be mounted on a processor of a general-purpose computer, a special-purpose computer, or other programmable data processing equipment, the instructions performed through the processor of the computer or other programmable data processing equipment create a means that performs the functions described in each block of the block diagram.

These computer program instructions may also be stored in a computer-usable or computer-readable recording medium (or memory) or the like, which may support a computer or other programmable data processing equipment, to implement the functions in a specific manner, so that the instructions stored in the computer-usable or computer-readable recording medium (or memory) may also produce manufactured products containing an instruction means for performing the functions described in each block of the block diagram.

In addition, since the computer program instructions may be mounted on a computer or other programmable data processing equipment, a series of operation steps are performed on the computer or other programmable data processing equipment to create a process executed by a computer, so that the instructions that operate the computer or other programmable data processing equipment may provide steps for performing the functions described in each block of the block diagram.

In addition, each block may represent a module, a segment, or part of a code including one or more executable instructions for executing specified logical function(s). In addition, it should also be noted that in some alternative embodiments, the functions mentioned in the blocks may be performed in an alternative order. For example, two blocks shown one after another may be performed simultaneously in practice, or the blocks may sometimes be performed in a reverse order according to a corresponding function.

The present invention may include an automated calculation module that integrates the weighted variables into a predictive model to compute real-time results. These results are transmitted to a user interface that displays calculated values such as stock price and net income in an accessible and actionable format. By applying weights and continuous learning, the invention improves the precision, reliability, and timeliness of forecasted values such as stock price and net income compared to conventional methods.

The present invention may utilize an artificial intelligence (AI) model that continuously refines its predictive accuracy by referencing both historical prediction values and corresponding actual values. The system collects two categories of past data: (i) prior prediction values generated by the model, and (ii) actual observed values corresponding to the same time intervals. By comparing these two datasets, the AI determines the degree of error associated with each prior prediction.

The AI engine assigns weighted values to the variables used in the prediction process according to their historical accuracy. Specifically, for each variable or feature (such as past stock prices, trading volume, company financial data, market indices, or external economic indicators), the system evaluates the extent to which the inclusion of that variable contributed to accurate or inaccurate predictions in the past. Variables that consistently correlate with accurate prediction outcomes are assigned higher weight values, whereas variables associated with larger prediction errors are reduced in weight. This weighting mechanism is dynamically updated as new prediction-versus-actual comparisons become available, ensuring that the model adapts to evolving market conditions.

The AI method may be implemented using supervised machine learning algorithms, such as regression models enhanced with adaptive weighting, neural networks with backpropagation-based error correction, or ensemble learning methods. In each case, the model incorporates a feedback loop wherein prediction errors are used to recalibrate variable weights. For example, in a neural network embodiment, the system calculates loss values based on differences between past predicted prices and actual outcomes; these loss values are propagated backward through the network to adjust connection weights assigned to each variable. In an ensemble embodiment, multiple sub-models may independently assign weights, and a meta-learner integrates these results to optimize the overall prediction.

Once the variable weights are recalibrated, the system applies them to current market data to compute updated value predictions. The calculation module integrates the current prediction value with the adjusted weighted variables to generate a future value forecast. This forecast is then output in real time to the user interface, providing continuously refined predictions that improve in accuracy as more historical prediction-versus-actual data is accumulated and analyzed.

In a further embodiment, the invention provides a method for issuing real-time warnings to users based on predicted value (such as stock price) fluctuations. The system not only generates future value predictions but also continuously monitors those predictions against pre-defined threshold conditions. These threshold conditions may be set automatically by the system or manually configured by the user according to investment strategies, such as maximum acceptable loss, minimum profit target, or volatility tolerance.

As an example, upon generating each prediction, the system compares the predicted stock price trajectory with the applicable thresholds. If the predicted price falls below a predefined lower threshold (e.g., a stop-loss value) or exceeds an upper threshold (e.g., a profit-taking value), the system triggers a warning. Such warnings may also be issued if the predicted price indicates a sudden change in trend, such as a sharp decline or surge beyond a statistically significant margin.

The warning module may operate in real time, meaning it is synchronized with the continuous data collection and prediction processes. As new market data is ingested and weighted predictions are recalculated, the system reevaluates threshold conditions without delay. If a risk condition is detected, the system immediately generates an alert message, which is transmitted to the user through a graphical user interface, push notification, email, or other electronic communication channel.

In one embodiment, the warning message contains not only the predicted stock price but also contextual information, such as the variables that most influenced the prediction, the degree of prediction confidence, and recommended user actions (e.g., “consider selling within 24 hours”). By coupling predictive analytics with an automated warning mechanism, the invention provides users with timely, actionable intelligence, thereby enhancing decision-making and reducing exposure to adverse market movements.

### DESCRIPTION OF SYMBOLS

100: Information manager-side apparatus
200: Data quantization apparatus
210: Interworking unit
220: Data reception unit
230: Reference value generation unit
240: Score calculation unit
250: Quantization unit
260: Data analysis unit

1. A data quantization method based on definite values and estimated values, the method comprising the steps of:
collecting, by a data quantization apparatus from at least two information manager-side apparatuses, data corresponding to a definite value of each preset period of a preset previous section based on a current date, an estimated value and a definite value of a current year based on the current date, and an estimated value of each period of a preset subsequent section based on the current date;
collecting a provision value that can be compared with the estimated values and the definite values, and calculating at least one comparison reference value on the basis of the provision value; and
quantizing the data of each period and section in a method of assigning a weight to the current year of each period and to each period of the previous section and subsequent section, by comparing the definite value of each period of the previous section, the definite value of each period of the current year, and the estimated value of each period of the subsequent section with the comparison reference value, wherein
the quantizing step includes the steps of:
calculating an average value for each period or each section using the definite value of each period of the previous section, the definite value of each period of the current year, and the estimated value of each period of the subsequent section;
calculating a score for each period of the previous section, the current year, and the subsequent section, by assigning a negative weight when the calculated average value is greater than the definite value or the estimated value of each period, and assigning a positive weight when the calculated average value is smaller than or equal to the definite value or the estimated value of each period;
calculating a total score of the previous section, the current year, and the subsequent section based on the score of each period of the previous section, the current year, and the subsequent section; and
generating a quantized graph using the total score and the score of each period of the previous section, the current year, and the subsequent section, and
the collected data are estimated and definite values of performance, and the provision value for comparison is net income and operating income, and an association data is an index-related graph.

2. The method according to claim 1, further comprising the steps of:
receiving association data related to the data from the outside; and
generating a comparative graph including a graph corresponding to the association data in a quantized graph.

3. The method according to claim 1, wherein the step of generating the comparison reference value includes the step of collecting the provision value through analysis of the data provided by a medium that posts data related to the provision value on the Internet, and then generating the comparison reference value on the basis of the collected provision value.

4. The method according to claim 1, wherein the assigning of the weighted values is performed using an artificial intelligence engine selected from the group consisting of regression models with adaptive weighting, neural networks with backpropagation error correction, and ensemble learning methods.
